(19) United States
(12) Patent Application Publication
(10) Pub. No.: US 2025/0035941 A1
(43) Pub. Date: Jan. 30, 2025

(54) SMART GLASSES AND MANUFACTURING METHOD THEREFOR

(71) Applicant: BEIJING SUPERHEXA CENTURY TECHONOLOGY CO., LTD., Beijing (CN)

(72) Inventors: Erwei Huo, Beijing (CN); Lijun Li, Beijing (CN); Ke Chen, Beijing (CN); Zunzhao Liu, Beijing (CN); Tianwei Yao, Beijing (CN); Liming Zhai, Beijing (CN); Yongfeng Xia, Beijing (CN)

(73) Assignee: BEIJING SUPERHEXA CENTURY TECHONOLOGY CO., LTD., Beijing (CN)

(21) Appl. No.: 18/838,232

(22) PCT Filed: Sep. 30, 2022
(86) PCT No.: PCT/CN2022/123630

§ 371 Date: Aug. 13, 2024

(30) Foreign Application Priority Data
Oct. 7, 2021 (CN) CN202111167628.7

(51) Int. Cl. G02B 27/01

(52) U.S. Cl. CPC G02B 27/0176; G02B 2027/0138; G02B 2027/0178

(57) ABSTRACT

Disclosed are smart glasses and a manufacturing method therefor. The smart glasses comprise a first assembly comprising a front crossbeam portion, a camera assembly and an optical mechanical assembly; and a second assembly comprising a rear crossbeam portion, a first temple and a second temple, wherein the first assembly is inserted into the second assembly. The first temple is provided with a first cavity; and the second temple is provided with a second cavity. A hollow passage for communicating the first cavity with the second cavity is enclosed by the front crossbeam portion and the rear crossbeam portion, the camera assembly is at least partially arranged in the first cavity, and the optical-mechanical assembly is at least partially arranged in the second cavity. The disclosed smart glasses have improved performance with enhanced convenience of assembly and ease of operation.

### CROSS-REFERENCE TO RELATED APPLICATION

This application is a Section 371 National Stage Application of International Application No. PCT/CN2022/123630, filed on Sep. 30, 2022, entitled “Smart glasses and a manufacturing method therefor”, which claims priority to Chinese Application No. 202111167628.7, filed on Oct. 7, 2021, incorporated herein by reference in their entirety.

### TECHNICAL FIELD

The present disclosure relates to the field of smart equipment/intelligent equipment. Specifically, it relates to smart glasses and a manufacturing method therefor, and in particular to a pair of head-mounted smart glasses with temples and its manufacturing method.

### BACKGROUND

Wearable smart devices, for example, smart watches, smart bracelets, smart glasses, etc., have been widely and commonly used at present. Among them, smart glasses have the characteristics of easy image presentation and convenient use, and have become more and more popular with consumers.

Accordingly, the functional requirements for smart glasses are increasing. However, due to the limit in the shape of glasses, it is difficult for smart glasses to carry so many circuits, batteries and structures. Furthermore, products in the form of helmets or similar shapes are easy to cause troubles when wearing, thus limiting their application.

In addition, as the functions of smart glasses become richer, their structure becomes more and more complex, and the manufacturing difficulty becomes higher and higher. This leads to rising cost, low production efficiency and inconvenience in maintenance. Therefore, it needs a kind of smart glasses that can be easily worn and manufactured.

### SUMMARY

The present disclosure is proposed based on the above-mentioned requirements in the background. The technical problem to be solved by the present disclosure is to provide a pair of smart glasses and a manufacturing method thereof, so as to conveniently install rich/various smart structures in a limited glasses space.

In order to solve the above technical problem, the technical solutions in the present disclosure include:

A pair of smart glasses, comprising:
a first assembly, comprising a front crossbeam portion, and a camera assembly and an optical-mechanical assembly respectively fixedly arranged on left and right sides of the front crossbeam portion;
a second assembly, comprising a rear crossbeam portion, and a first temple and a second temple respectively fixedly arranged on left and right sides of the rear crossbeam portion, wherein the first temple has a first cavity, and the second temple has a second cavity;
wherein the first assembly and the second assembly are connected through a plugging-in way; the front crossbeam portion and the rear crossbeam portion form a hollow passage connecting the first cavity and the second cavity, and the camera assembly is at least partially arranged in the first cavity, and the optical-mechanical assembly is at least partially arranged in the second cavity.

According to some embodiments of the present disclosure, the first cavity is located at a front end of the first temple, and the second cavity is located at a front end of the second temple.

According to some embodiments of the present disclosure, the first cavity and the second cavity are symmetrical to each other.

According to some embodiments of the present disclosure, the first temple and the second temple are symmetrical to each other.

According to some embodiments of the present disclosure, the left and right ends of the front crossbeam portion are respectively fixedly connected to the camera assembly and the optical-mechanical assembly; the left and right ends of the rear crossbeam portion are respectively fixedly connected to the first temple and the second temple.

According to some embodiments of the present disclosure, the first temple comprises a front end, a rear end, an inner side and an outer side, the inner side is substantially a plane, a front end of an outer side edge of the first temple protrudes outward and downward to form the first cavity; the first cavity of the first temple gradually narrows upward and inward from front to back; the rear end of the first temple is provided with a bending portion which cooperates with an ear root.

According to some embodiments of the present disclosure, the second temple comprises a front end, a rear end, an inner side and an outer side; the inner side is substantially a plane, a front end of an outer side edge of the second temple protrudes outward and downward to form the second cavity; the second cavity of the second temple gradually narrows upward and inward from front to back; the rear end of the second temple is provided with a bending portion which cooperates with an ear root.

According to some embodiments of the present disclosure, the camera assembly and the optical machine assembly each comprise: a panel, an optical device and a control circuit board;
the panel is arranged at one side end of the front crossbeam portion and closes an opening of the cavity from the front end of the temple;
the optical device is arranged on a front surface of the panel;
the control circuit board is arranged on a rear surface of the panel and inserted into the cavity through the opening of the cavity in the temple.

In addition, the present patent further discloses a method for manufacturing the pair of smart glasses according to any one of above embodiments, comprising: obtaining a first assembly; obtaining a second assembly; inserting the first assembly into the second assembly, and fixing the first assembly and the second assembly.

According to some embodiments of the present disclosure, the obtaining the first assembly comprises fixing the optical-mechanical assembly and the camera assembly to the front crossbeam portion.

According to some embodiments of the present disclosure, optical components of the optical-mechanical assembly and the camera assembly are arranged on a front surface of the front crossbeam portion; and control circuit boards of the optical-mechanical assembly and the camera assembly are arranged on a rear surface of the front crossbeam portion.

By adopting the above technical solutions, the smart glasses are divided into two assemblies, the front assembly is used to carry the main optical and circuit components, and the rear assembly uses the temples to provide installation space. The integrated front assembly and the integrated rear assembly are then assembled together, which can reduce the difficulty of assembly and provide abundant space for setting complex control components, thereby providing better performance for the smart glasses while improving the convenience of installation and operation.

### BRIEF DESCRIPTION OF THE DRAWINGS

In order to more clearly illustrate the technical solutions in the embodiments of the present disclosure or the prior art, the drawings required for description of the embodiments or the prior art will be briefly introduced below. Obviously, the drawings described below only reflect some of the embodiments of the present disclosure, and other drawings can be obtained by those skilled in the art based on these drawings.

FIG. 1 is a structural view of smart glasses in a specific embodiment of the present disclosure;

FIG. 2 is a schematic view of the front half of the smart glasses in a specific embodiment of the present disclosure;

FIG. 3 is a schematic view of the rear half of the smart glasses in a specific embodiment of the present disclosure;

FIG. 4 is a schematic view showing the assembly of the front and rear portions of the smart glasses in the present disclosure;

FIG. 5 is a flow chart of a method for manufacturing smart glasses in a specific embodiment of the present invention.

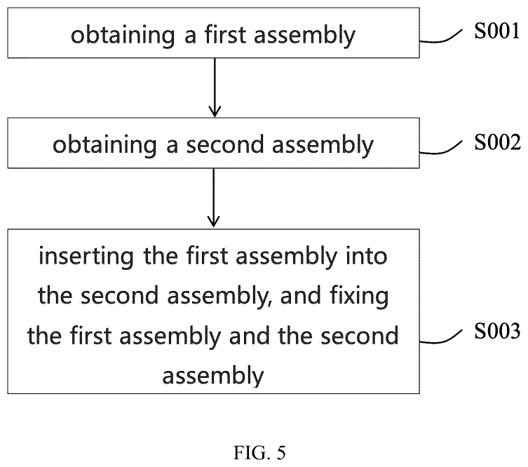

### DETAILED DESCRIPTION OF EMBODIMENTS

In order to make the purpose, technical solutions and advantages of the embodiments of the present disclosure clearer, the technical solutions in the embodiments of the present disclosure will be clearly and completely described in combination with the drawings in the embodiments of the present disclosure. Obviously, the described embodiments are just part of the present disclosure, not represent the whole of the present disclosure. Based on the embodiments in the present disclosure, other embodiments that may be obtained by those skilled in the art without creative work fall within the scope of protection of the present disclosure.

In order to facilitate the understanding of the embodiments of the present disclosure, the following specific embodiments will be further explained in combination with the drawings. The embodiments do not constitute a limitation on the present disclosure.

### Embodiment 1

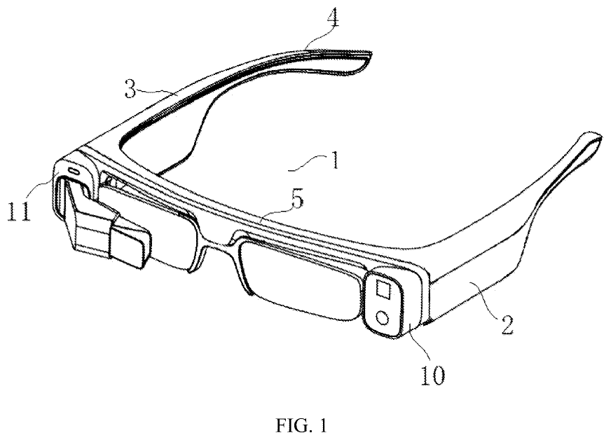

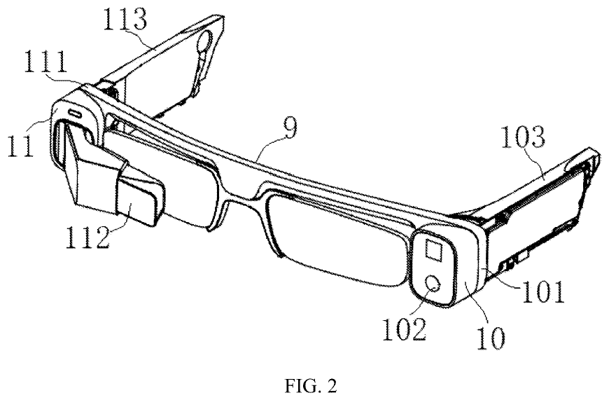

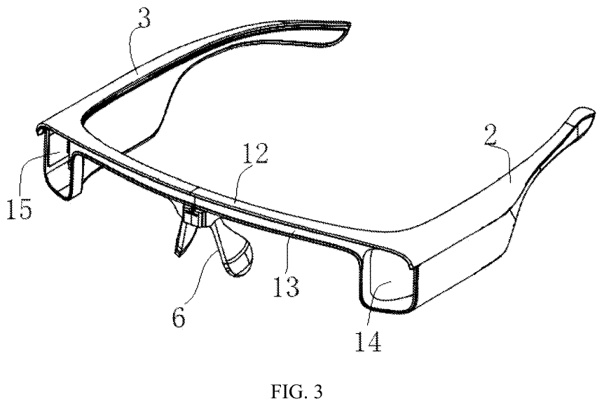

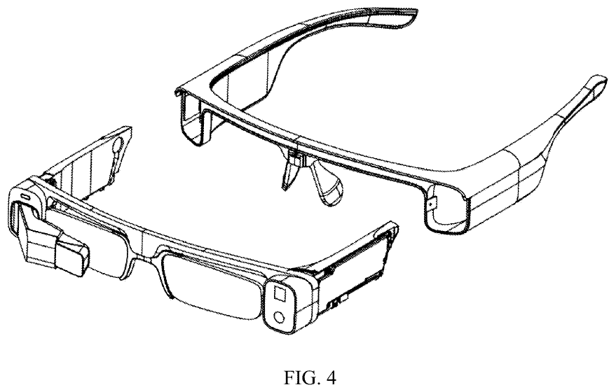

This embodiment provides a kind of smart glasses 1, whose structure is shown in FIGS. 1 to 4. In these specific embodiments, the front, rear, left, right, top and bottom of the smart glasses are exemplarily defined as follows: As shown in FIG. 1, the direction of the smart glasses toward the human eyes is defined as the rear, and the opposite direction away from the human eye is defined as the front; the direction of the smart glasses toward the top of the head is defined as the top, and the direction toward the feet is defined as the bottom; the side of the smart glasses close to the face is defined as the inside, and the side away from the face may be the outside. It should be noted that the definitions of up, down, inside, outside, front, and rear will be different depending on the reference system. Therefore, the above-mentioned definitions of positions are used as examples in the present disclosure to facilitate the description of the technical solution of these specific embodiments.

In these specific embodiments, the smart glasses 1 first have the form of glasses, that is, the glasses understood by ordinary technicians, and their notable feature is that they include temples, including a left temple 2 and a right temple 3, which are respectively arranged on both sides of the face, and the temples are placed on the upper part of the ear roots of the person through brackets 4 bent downward at the rear side of the temples. The left temple 2 and the right temple 3 are connected by a crossbeam 5, and the crossbeam is arranged across the width of the face. A nose pad 6 is arranged on the crossbeam to support the front end of the glasses at the nose, preferably at the bridge of the nose, so as to form a glasses structure that can be stably mounted/worn on the face.

In these specific embodiments, the smart glasses may include lenses or not. If lenses are provided, the lenses are preferably a pair connected to the crossbeam. In these specific embodiments, the lenses can be detachably connected.

Smart glasses are called smart/intelligent because their main functions in these specific embodiments include intelligent functions, such as taking pictures or displaying through a near-eye display device. In addition to taking pictures and near-eye display, the smart glasses can optionally include the function of touch operation, for completing other functions such as computer program instructions.

Due to the form of glasses, which is significantly different from products such as eye masks and helmets, the weight and space size of smart glasses are obviously limited. However, as consumers' demand for smart functions increases, devices such as batteries and processors need to be supported by more powerful modules (taking “taking pictures” function as an example, the requirements for the performance of taking pictures lead to the increasing size of the components of the camera), which inevitably leads to an increase in size and an increase in the complexity of the system. But as a result, it forms a main contradiction between the convenience of manufacturing and the comfort of wearing glasses.

In this specific embodiment, the smart glasses include two assemblies that are arranged in a front-rear direction, namely, a first assembly 7 and a second assembly 8, and the manufacturing of the device is facilitated by assembling the first assembly and the second assembly.

As shown in the drawings, in this specific embodiment, the first assembly includes a front crossbeam portion 9, and a camera assembly 10 and an optical-mechanical (optical machine) assembly 11 respectively arranged on the left and right sides of the front crossbeam portion.

The front crossbeam portion is a half area of the crossbeam, and is provided across the entire face. In these specific embodiments, the front crossbeam portion is formed into a plate shape as a whole, including a beam plate. The plate-shaped front crossbeam portion is convenient for carrying and installing optical-mechanical assembly and camera assembly, and can easily block the opening at the front end of the second assembly, to form a closed cavity structure inside the smart glasses.

On one side of the front crossbeam portion, the left side as shown in the drawings, a camera assembly 10 is provided. The camera assembly includes a panel 101, an optical device 102 and a control circuit board 103; the panel 101 and the front crossbeam portion are fixedly connected or integrally formed as a part of the front crossbeam portion. Preferably, the panel is provided at the left end of the front crossbeam portion. The panel and its attached frame are used as a supporting member to set up the camera assembly. Since there are no obstructions on the front and rear of the panel, in this case, setting up the above structure is easy to operate and implement during the manufacturing and assembly process.

In these specific embodiments, the optical device/component 102 of the camera is disposed outside the panel 101. In the camera, the optical device preferably includes a lens component, etc. Since the lens component needs to collect light from the external environment, it needs to be disposed on the outside of the panel, or at least face towards the outside of the panel. A control circuit board 103 is provided on the inner side of the panel assembly. The control circuit board may be a single circuit board or may be formed of multiple circuit boards, for example, a camera control circuit board, a battery, a main control chip of glasses, etc. The control circuit board can be packaged together as a whole, which is beneficial to maintaining the overall shape of the circuit board and facilitating assembly into the temples.

The optical-mechanical assembly 11 is disposed on the right side of the front crossbeam portion. The optical-mechanical assembly is a component used to provide near-eye display. Users wearing the smart glasses can observe images through the optical-mechanical assembly, and the images can also be superimposed to the real scenes to play the role of augmented reality. The optical-mechanical assembly/components can use components in the prior art, including optical lens assembly 112 (optical element), a display (not shown in the drawings) and a control circuit board 113. The control circuit board 113 controls the display to display the corresponding images, and transmit the images to the human eye through the optical lens assembly 112. In this specific embodiment, the optical elements of the optical-mechanical assembly are arranged on the outside of the right side panel 111 so as to extend to the front of the human eye. The control circuit board 113 of the optical-mechanical assembly also extends backward from the right side panel. Similarly, the control circuit board 113 may further include one or more circuit boards. Preferably, they are also packaged together in an integral package to maintain the overall shape of the circuit boards and facilitate assembly them into the temple.

In this specific embodiment, through the structure of the first assembly, the camera assembly and the optical-mechanical assembly can be installed on both sides of the front crossbeam portion without obstruction, making it easy to install components with complex mechanical structures and circuit structures, and improving the work efficiency.

In these specific embodiments, the smart glasses also include a second assembly 8. The second assembly includes a rear crossbeam portion 12. The rear crossbeam portion and the front crossbeam portion are arranged oppositely. The rear crossbeam portion is provided with a groove 13 which opens forward. When the front crossbeam portion and the rear crossbeam portion are relatively abutted, the front crossbeam portion and the rear crossbeam portion enclose and form a passage, connecting the left and right sides of the glasses. The passage can be used for wiring, thereby increasing the space for wiring. In this way, the thinner crossbeam can meet the wiring requirements; due to the large wiring space, relatively balanced structures can be set on the left and right sides of the smart glasses, and the communication on both sides can still be relatively smooth.

The second assembly further includes a first temple and a second temple, that is, a left temple 2 and a right temple 3, arranged on the left and right sides of the rear crossbeam portion. The first temple has a first cavity 14, the second temple has a second cavity 15; both side ends of the groove 13 of the rear crossbeam portion are communicated with the first cavity 14 and the second cavity 15, so that the wires in the first cavity or the second cavity can be conveniently led to the other side through the passage in the crossbeam.

In these specific embodiments, the first cavity and the second cavity are respectively provided in the temples on the left and right sides, and are located at the front of the temples. That is to say, in these specific embodiments, the temple is basically a whole body, and the cavity is provided inside the housing of the temple; through this arrangement, the temple can be manufactured basically as a whole, thereby reducing the number of assembled parts. In these specific embodiments, the inner side of the temples is basically horizontal; in order to increase the volume of the cavities, the first cavity and the second cavity are protruding outward from the temples on the left and right sides respectively, thus it will not affect wearing, and at the same time, it can increase the accommodation volume of the cavities to facilitate the installation of more complex and large-scale circuit structures.

The front ends of the first cavity and the second cavity have openings to facilitate the insertion of the components of the first assembly therein. At the rear of the first cavity and the second cavity, that is, at the middle of the temples, the cavities gradually narrow to smoothly transition to the brackets for the ear roots at the rear end of the temples. In these specific embodiments, the cavity is preferably gradually narrowed from bottom to top, in this way, it does not affect the experience of wearing glasses. In addition, the narrowed part can be used to set an opening to connect other devices other than the glasses to the glasses.

In the second assembly, the temples on the left and right sides are basically symmetrically arranged, and the shape and size of the first cavity and the second cavity are also basically the same and symmetrically arranged, which is beneficial to the balance when wearing the glasses, thereby improving the wearing experience.

The first assembly and the second assembly are combined together by plugging-in. Specifically, when the two are to be combined, the front crossbeam portion and the rear crossbeam portion are relatively close to each other, and the front crossbeam portion and the rear crossbeam portion face to each other to form a passage. The control circuit boards of the camera assembly and the optical-mechanical assembly on both sides of the first assembly are respectively inserted into the first cavity and the second cavity in the first temple and the second temple. In these specific embodiments, the shapes of the control circuit boards in the first cavity and the second cavity respectively match the shapes of the first cavity and the second cavity; after being plugged in, the cavity size of the temple can be as small as possible to reduce the weight of smart glasses and maintain a suitable shape. In the first assembly, the panels for the camera assembly and the optical-mechanical assembly respectively close the openings of the first cavity and the second cavity at the ends of the first cavity and the second cavity, so that an internal space is formed inside the glasses, the internal space is formed by the first cavity, the second cavity, and a pipe connecting the first cavity and the second cavity. Various circuit structures are provided in this internal space.

Because in the first assembly, there is no obstruction on the front and rear sides of the front crossbeam portion, it can be operated from both sides. When installing optical devices and control circuits, it is not limited by space and can be installed conveniently. The second assembly is mainly formed as an accommodation space. After the assembly of the first assembly is completed, the first assembly can be conveniently inserted into the accommodation space of the second assembly based on the positioning of the front and rear assemblies. In addition, in this embodiment, the space for accommodating the components of the smart glasses is not only sufficient but also balanced on the left and right. On the premise that the overall shape of the glasses is maintained, devices with better performance can be installed and the functions of the smart glasses can be optimized.

### Embodiment 2

This embodiment provides a method for manufacturing smart glasses. The method for manufacturing smart glasses in this specific embodiment is used to manufacture the smart glasses described in Embodiment 1.

In this Embodiment 2, the method includes the following steps:

S001 obtaining the first assembly

In this step, the first assembly may be an assembled first assembly. That is, the first assembly has been assembled with the front crossbeam portion, the camera assembly and the optical-mechanical assembly. In the first assembly, the optical machine (optical-mechanical assembly) and the camera are fixed on the front crossbeam portion; the optical devices of the optical machine and the camera are arranged on the front surface of the front crossbeam portion; the control circuit boards of the optical machine and the camera are arranged on the rear surface of the front crossbeam portion.

In addition to the above solutions, in this specific embodiment, obtaining the first assembly may further include assembling various parts into the first assembly, for example, assembling the optical-mechanical assembly and the camera assembly, and then fixing them to the front crossbeam portion.

During the manufacturing process, the first assembly is not interfered with by the front crossbeam portion in the front and rear directions, so that there is a large space for setting up a working mechanism or for manual operation, thus improving the convenience of assembly and improving work efficiency.

S002 obtaining the second assembly

In this step, the second assembly is the second assembly described in Embodiment 1. Obtaining the second assembly may include obtaining the structure of the second assembly that has been made, or may include the process of manufacturing the second assembly, for example, through mold manufacturing, three-dimensional printing, or assembly.

S003 inserting the first assembly into the second assembly, and fixing the first assembly and the second assembly.

In this step, the circuit board of the first assembly is inserted into the cavity of the second assembly, and the two half crossbeams of the first assembly and the second assembly, that is, the front crossbeam portion of the first assembly and the rear crossbeam portion of the second assembly are attached, and then the first assembly and the second assembly are combined together, thus forming a pair of smart glasses with an internal cavity for accommodating circuits.

In this embodiment, a modular assembly method is used to manufacture the smart glasses, which reduces the difficulty of assembly, facilitates assembly, and is beneficial to improving the assembly efficiency and product quality of the smart glasses.

The above-mentioned specific embodiments further describe the purpose, technical solutions and beneficial effects of the present disclosure in detail. It should be understood that the above-mentioned only reflects the specific embodiments of the present disclosure but are not intended to limit the scope of the present disclosure. Any modifications, equivalent replacements, improvements, etc. made within the spirit and principles of the present disclosure shall be included in the scope of protection of the present disclosure.

What is claimed is:

1. A pair of smart glasses, comprising:
a first assembly, comprising a front crossbeam portion, and a camera assembly and an optical-mechanical assembly respectively fixedly arranged on left and right sides of the front crossbeam portion;
a second assembly, comprising a rear crossbeam portion, and a first temple and a second temple respectively fixedly arranged on left and right sides of the rear crossbeam portion, wherein the first temple has a first cavity, and the second temple has a second cavity;
wherein the first assembly and the second assembly are connected through a plugging-in way; the front crossbeam portion and the rear crossbeam portion form a hollow passage connecting the first cavity and the second cavity, and the camera assembly is at least partially arranged in the first cavity, and the optical-mechanical assembly is at least partially arranged in the second cavity.

2. The pair of smart glasses according to claim 1, wherein the first cavity is located at a front end of the first temple, and the second cavity is located at a front end of the second temple.

3. The pair of smart glasses according to claim 1, wherein the first cavity and the second cavity are symmetrical to each other.

4. The pair of smart glasses according to claim 1, wherein the first temple and the second temple are symmetrical to each other.

5. The pair of smart glasses according to claim 4, wherein the left and right ends of the front crossbeam portion are respectively fixedly connected to the camera assembly and the optical-mechanical assembly; the left and right ends of the rear crossbeam portion are respectively fixedly connected to the first temple and the second temple.

6. The pair of smart glasses according to claim 5, wherein the first temple comprises a front end, a rear end, an inner side and an outer side, the inner side is substantially a plane, a front end of an outer side edge of the first temple protrudes outward and downward to form the first cavity; the first cavity of the first temple gradually narrows upward and inward from front to back; the rear end of the first temple is provided with a bending portion which cooperates with an ear root.

7. The pair of smart glasses according to claim 6, wherein the second temple comprises a front end, a rear end, an inner side and an outer side; the inner side is substantially a plane, a front end of an outer side edge of the second temple protrudes outward and downward to form the second cavity; the second cavity of the second temple gradually narrows upward and inward from front to back; the rear end of the second temple is provided with a bending portion which cooperates with an ear root.

8. The pair of smart glasses according to claim 5, wherein the camera assembly and the optical machine assembly each comprise: a panel, an optical device and a control circuit board;
the panel is arranged at one side end of the front crossbeam portion and closes an opening of the cavity from the front end of the temple;
the optical device is arranged on a front surface of the panel;
the control circuit board is arranged on a rear surface of the panel and inserted into the cavity through the opening of the cavity in the temple.

9. A method for manufacturing the pair of smart glasses according to claim 1, comprising:
obtaining a first assembly;
obtaining a second assembly;
inserting the first assembly into the second assembly, and fixing the first assembly and the second assembly.

10. The method according to claim 9, wherein the obtaining the first assembly comprises fixing the optical-mechanical assembly and the camera assembly to the front crossbeam portion.

11. The method according to claim 10, wherein optical components of the optical-mechanical assembly and the camera assembly are arranged on a front surface of the front crossbeam portion; and control circuit boards of the optical-mechanical assembly and the camera assembly are arranged on a rear surface of the front crossbeam portion.
